(19) United States
(12) Patent Application Publication
(10) Pub. No.: US 2008/0008892 A1
(43) Pub. Date: Jan. 10, 2008

(54) Powder-compressed assembly and manufacturing method thereof

(75) Inventors: Ru-Kuen Huang, Taoyuan Hsien (TW); Chieh-Cheng Chen, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/806,937

(22) Filed: Jun. 5, 2007

(30) Foreign Application Priority Data
Jun. 23, 2006 (TW) 95122718

(51) Int. Cl. B32B 15/00; B23P 11/00; H01F 41/00

(52) U.S. Cl. 428/457; 29/505; 29/602.1

(57) ABSTRACT

A powder-compressed assembly including a pressed main body and at least one clip is disclosed. The pressed main body has at least one predetermined recess, and the clip functions as an externally connecting contact. When the pressed main body and the clip are assembled, the clip is deformedly pressurized for engagement with the predetermined recess, thereby tightly combining the pressed main body and the clip. Also, a manufacturing method of the above-mentioned powder-compressed assembly is disclosed.

### BACKGROUND OF THE INVENTION

This Non-provisional application claims priority under U.S.C.§119(a) on Patent Application No(s). 095122718 filed in Taiwan, Republic of China on Jun. 23, 2006, the entire contents of which are hereby incorporated by reference.

### FIELD OF THE INVENTION

The invention relates to a powder-compressed assembly, and more particularly to a powder-compressed assembly and the manufacturing method thereof capable of facilitating the assembling process.

### DESCRIPTION OF THE RELATED ART

A metal clip typically functions as a contact for connection of external electronics. In FIG. 1A, an inductor 10 has a plastic body 12, two metal clips 14a and 14b disposed around the body 12, and an adhesive 16 disposed between the body 12 and the metal clips 14a and 14b.

In FIGS. 1B and 1C, the uncured adhesives 16 are adhered to the inner surfaces of the metal clips 14a and 14b in a gluing process. The metal clips 14a and 14b are disposed on the body 12 until the adhesives 16 are cured. A glue-baking process may be additionally performed to cure the adhesives 16 more rapidly after the gluing process, and an additional heating device is required for the glue-baking process. Thus, surfaces of the metal clips 14a and 14b can function as contacts for external connection.

However, the gluing process is manually performed. As the results, the curing time and properties of the adhesive cannot be effectively controlled, the condition of the connection cannot be easily observed by appearance, and the body and the metal clips cannot be precisely positioned therebetween. Therefore, the cost of additional devices, gluing material and the fabrication time cannot be decreased.

Further, the body 12 is broken if the small thickness thereof cannot support the loading. Alternatively, if the thickness of the body 12 is enlarged, this causes the volume of the inductor 10 to increase.

### BRIEF SUMMARY OF THE INVENTION

To solve the described problems, the present invention provides a powder-compressed assembly and a manufacturing method thereof to achieve a good position effect of a body and a metal clip by a simplified assembling process. Also, the quality of the products such as inductors can be increased, and the productive process can be simplified.

A powder-compressed assembly according to an embodiment of the present invention includes a pressed main body and at least one clip. The pressed main body is a powder-compressed main body, and the at least one clip is a metal clip. The pressed main body has at least one predetermined recess, and the metal clip functions as an external connection contact. The metal clip is deformedly pressurized for engaging the predetermined recess when the pressed main body and the metal clip are assembled, thereby tightly combining the pressed main body and the clip.

Also, a manufacturing method of a powder-compressed assembly is disclosed. The method includes the following steps: providing a pressed main body including at least one predetermined recess; providing at least one clip functioning as an external connection contact; assembling the pressed main body and the metal clip; and deformedly pressurizing the clip to be engaged to the predetermined recess, thereby tightly combining the pressed main body and the clip.

The cross section of the predetermined recess of the pressed main body includes an internal slant angle. The internal slant angle is substantially equal to 12-15 degrees with respect to a horizontal level. The powder-compressed assembly further includes a jig used to exert a force and permanently deform the metal clip so as to allow the clip to be engaged with the predetermined recess. In this embodiment, the number of metal clips is two, and the pressed main body includes a first lateral side, a second lateral side opposite to the first lateral side, and two predetermined recesses respectively close to the first lateral side and the second lateral side for allowing the metal clips to be engaged with the predetermined recesses, respectively. The metal clip includes a first end and a second end, and the pressed main body includes a top side, a bottom side opposite to the top side, and two predetermined recesses respectively disposed at the top side and the bottom side, for allowing the first end and the second end of the clip to be engaged with the predetermined recesses, respectively.

In addition, the predetermined recess is formed with the pressed main body as a single piece by a single powder-compressed casting formation. The powder-compressed assembly is applied to a surface mount technology (SMT) component, such as an inductor.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic view of a conventional inductor before assembling.

FIG. 1B is a schematic sectional view of the conventional inductor before assembling.

FIG. 1C is a schematic sectional view of the assembled conventional inductor.

FIG. 2A is a schematic view of a powder-compressed assembly before assembling according to a first embodiment of the present invention.

FIGS. 2B and 2C are schematic views of the powder-compressed assembly during assembling according to the first embodiment of the present invention.

FIG. 2D is a schematic view of the assembled powder-compressed assembly according to the first embodiment of the present invention.

FIG. 2E is a schematically sectional view of the powder-compressed assembly of FIG. 2A.

FIG. 2F is a schematically sectional view of the assembled powder-compressed assembly of FIG. 2D.

FIG. 3A is a schematic view of a powder-compressed assembly before assembling according to a second embodiment of the present invention.

FIG. 3B is a schematic view of the assembled powder-compressed assembly according to the second embodiment of the present invention.

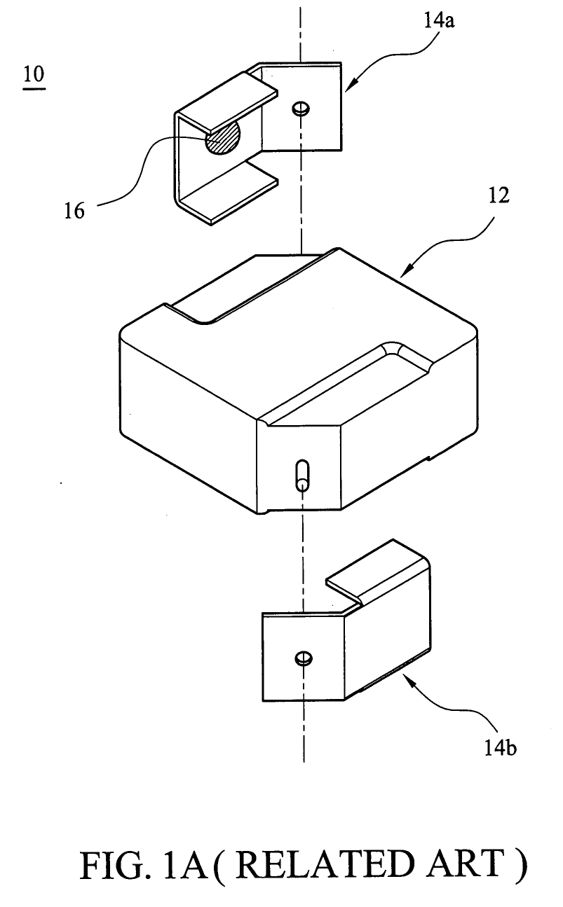

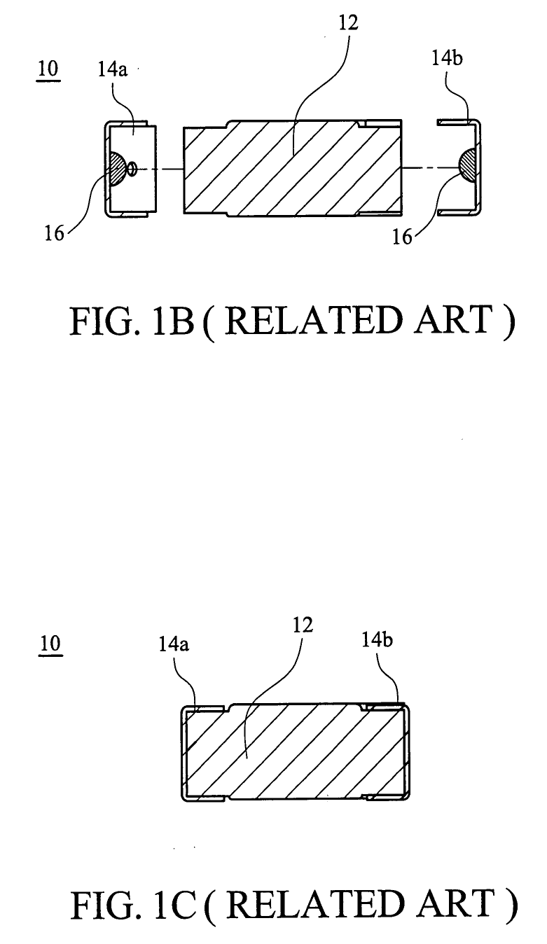

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

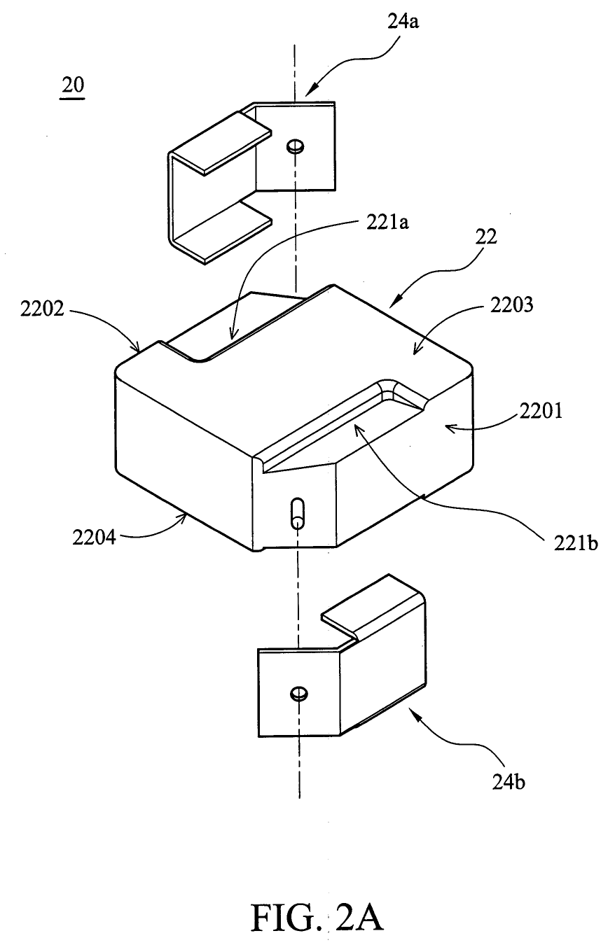

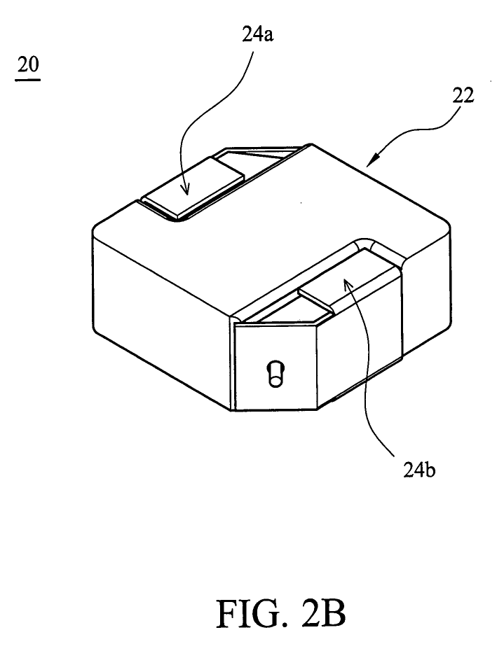

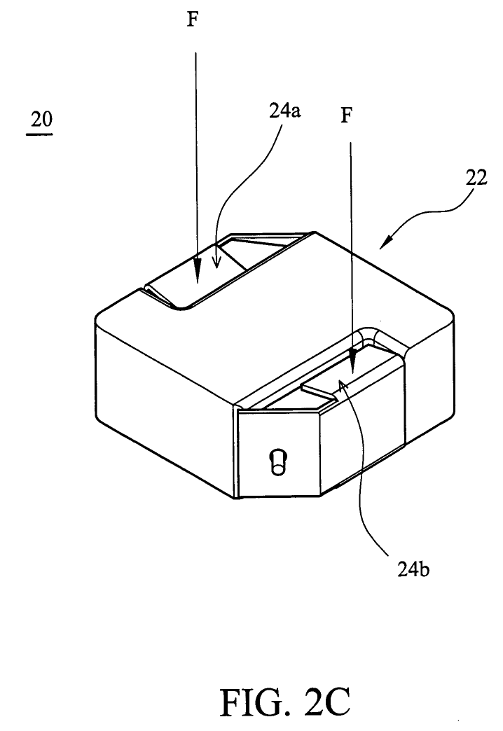

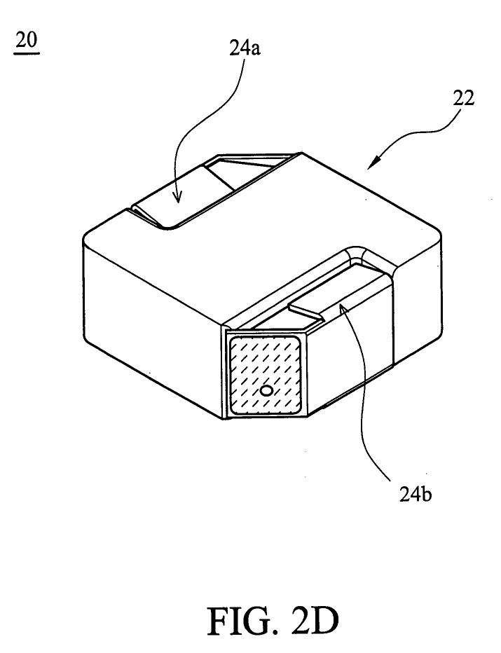

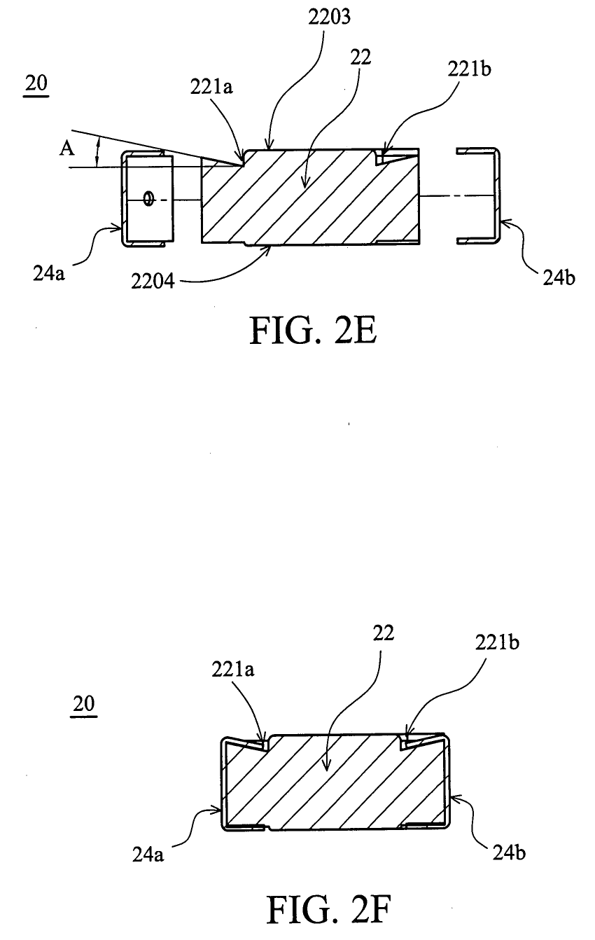

FIG. 2A shows a powder-compressed assembly 20 according to a first embodiment including a pressed main body 22 and two metal clips 24a and 24b, each of which functions as an external connecting contact. The pressed main body 22 includes a first lateral side 2201, a second lateral side 2202 opposite to the first lateral side 2201, a top side 2203, a bottom side 2204 opposite to the top side 2203. Also, the pressed main body 22 includes two predetermined recesses 221a and 221b are respectively close to the first lateral side 2201 and the second lateral side 2202 for allowing the metal clips 24a and 24b to be engaged with the predetermined recesses 221a and 221b, respectively. It is noted that the first lateral side 2201 and the second lateral side 2202 are respectively defined as sidewall parts of the pressed main body 22, and the top side 2203 and the bottom side 2204 are respectively defined as upper and lower parts of the pressed main body 22. In FIG. 2A, the predetermined recesses 221a and 221b, respectively close to the first lateral side 2201 and the second lateral side 2202, are both disposed at the top side 2203 of the pressed main body 22.

In the first embodiment, the powder-compressed assembly 20 can be applied to a surface mount technology (SMT) component, such as an inductor. The pressed main body 22 can be a seat of the inductor.

In FIGS. 2B and 2C, the metal clips 24a and 24b are deformedly pressurized to engage to the predetermined recesses 221a and 221b when the pressed main body 22 and the metal clips 24a and 24b are assembled, thereby tightly combining the pressed main body 22 and the metal clips 24a and 24b. In FIG. 2D, a jig (not shown in Fig.) is additionally used to exert a force and permanently deform the metal clips 24a and 24b so as to allow the metal clips 24a and 24b to be mechanically and to be tightly engaged with the predetermined recesses 221a and 221b. In FIG. 2E, each cross section of the predetermined recess 221a and 221b includes an internal slant angle “A”, which substantially equals to 12-15 degree with respect to a horizontal level.

Since the jig exerts a force and permanently deforms the metal clips 24a and 24b and mechanically engages the deformed metal clips 24a and 24b to the predetermined recesses 221a and 221b, the metal clips 24a and 24b can be directly connected to the pressed main body 22 instead of gluing. Therefore, the electronics can be prevented from being damaged caused by high temperature gluing. Thus, the gluing process and the heating apparatus thereof can be eliminated and the production process can be simplified.

The predetermined recesses 221a and 221b are formed with the pressed main body 22 as a single piece by a single powder-compressed casting formation. That is to say, the predetermined recesses 221a and 221b can be directly formed on the formation of the pressed main body 22, thus to receive the deformed metal clips 24a and 24b therein, to prevent the electronics from being damaged and to snuggly engage the deformed metal clips 24a and 24b to the pressed main body 22.

Also, a manufacturing method of a powder-compressed assembly 20 according to embodiments includes the following steps: providing a pressed main body 22 including at least one predetermined recess 221a and 221b; providing at least one metal clip 24a and 24b functioned as an externally connecting contact; assembling the pressed main body 22 and the metal clip 24a and 24b; and deformedly pressurizing the metal clip 24a and 24b to be engaged to the predetermined recesses 221a and 221b, thereby tightly combining the pressed main body 22 and the metal clip 24a and 24b.

It is to be understood that the embodiment is not limited thereto. The method of the embodiment can be applied to any electronic devices which require assembly of a body and a metal clip. Also, it is noted that all predetermined recesses in the first embodiment are located on the top side 2203 of the pressed main body 22, but the present invention is not limited thereto.

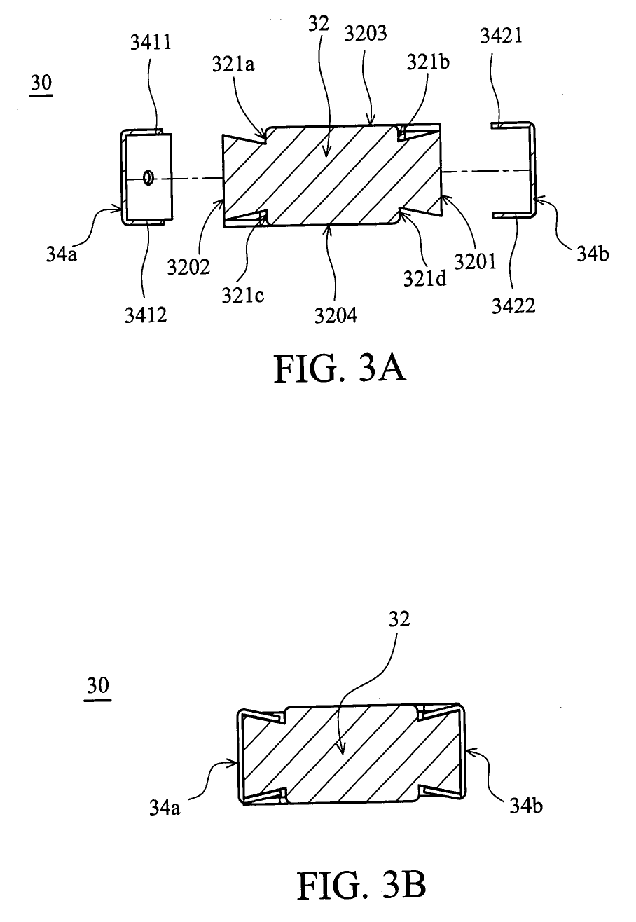

Referring both to FIGS. 3A and 3B, FIG. 3A shows a powder-compressed assembly 30 according to a second embodiment of the present invention. The powder-compressed assembly 30 includes a pressed main body 32, a first metal clip 34a and a second metal clip 34b. The pressed main body 32 includes a first lateral side 3201, a second lateral side 3202 opposite to the first lateral side 3201, a top side 3203, a bottom side 3204 opposite to the top side 3203, two upper predetermined recesses 321a and 321b disposed at the top side 3203, and two lower predetermined recesses 321c and 321d disposed at the bottom side 3204. The first metal clip 34a includes a first end 3411 and a second end 3412, and the second metal clip 34b includes a first end 3421 and a second end 3422. The first lateral side 3201and the second lateral side 3202 are respectively defined as sidewall parts of the pressed main body 32, and the top side 3203 and the bottom side 2204 are respectively defined as upper and lower parts of the pressed main body 32.

In FIG. 3B, when the pressed main body 32 and the first and second metal clips 34a and 34b are assembled, the first and second ends 3411 and 3412 of the first metal clip 34a are respectively engaged to the predetermined recesses 321a and 321c and the first and second ends 3421 and 3422 of the second metal clip 34b are respectively engaged to the predetermined recesses 321b and 321d.

The first and second metal clips 34a and 34b are deformedly pressurized to engage to the upper and lower predetermined recesses 321a/321b and 321c/321d of the pressed main body 32 when the pressed main body 32 and the first and second metal clips 34a and 34b are assembled. As the results, the pressed main body 32 and the first and second metal clips 34a and 34b are tightly combined. Also, the powder-compressed assembly 30 further includes a jig (not shown in Fig.) used to permanently deform the first and second metal clips 34a and 34b, thus to mechanically and tightly engage the deformed first and second metal clips 34a and 34b to the upper and lower predetermined recesses 321a/321b and 321c/321d of the pressed main body 32.

In summary, the powder-compressed assembly and the manufacturing method thereof according to embodiments of the present invention have features like designing a pressed main body with at least one predetermined recess and a deformedly pressurized metal clip which is engaged to the predetermined recess when the pressed main body and the metal clip are assembled by deformedly pressurizing the clip, and thus the pressed main body and the metal clip are tightly combined. As the results, gluing and glue-baking processes can be eliminated, but a good position effect of a body and a metal clip is still able to be achieved by a simplified assembling process. Also, the quality of the products such as inductors can be increased, and the productive process can be simplified.

Instead of conventional gluing process, the present invention provides a strengthened powder-compressed assembly without any requiring adhesives or glues, and the powder-compressed assembly can be qualified via eye-sight according to the deformation angle thereof, thus, easily controlling quality and simplifying.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A powder-compressed assembly, comprising:
a pressed main body comprising at least one predetermined recess; and
at least one clip functioning as an external connecting contact, wherein the clip is deformedly pressurized to be engaged to the predetermined recess when the pressed main body and the metal clip are assembled, thereby tightly combining the pressed main body and the clip.

2. The powder-compressed assembly as claimed in claim 1, wherein a cross section of the predetermined recess comprises an internal slant angle.

3. The powder-compressed assembly as claimed in claim 2, wherein the internal slant angle is substantially equal to 12-15 degree with respect to a horizontal level.

4. The powder-compressed assembly as claimed in claim 1, further comprising a jig used to exert a force and permanently deform the clip so as to allow the clip to be engaged with the predetermined recess.

5. The powder-compressed assembly as claimed in claim 1, wherein the powder-compressed assembly comprises two clips, and the pressed main body comprises a first lateral side, a second lateral side opposite to the first lateral side, and two predetermined recesses respectively close to the first lateral side and the second lateral side for allowing the clips to be engaged with the predetermined recesses, respectively.

6. The powder-compressed assembly as claimed in claim 1, wherein the clip comprises a first end and a second end, and the pressed main body comprises a top side, a bottom side opposite to the top side, and two predetermined recesses respectively disposed at the top side and the bottom side, for allowing the first end and the second end of the clip to be engaged with the predetermined recesses, respectively.

7. The powder-compressed assembly as claimed in claim 1, wherein the predetermined recess is formed with-the pressed main body as a single piece by a single powder-compressed casting formation.

8. The powder-compressed assembly as claimed in claim 1, wherein the powder-compressed assembly is applied to a surface mount technology component.

9. The powder-compressed assembly as claimed in claim 8, wherein the surface mount technology component comprises an inductor.

10. The powder-compressed assembly as claimed in claim 1, wherein the pressed main body is a powder-compressed main body, and the at least one clip is a metal clip.

11. A manufacturing method of a powder-compressed assembly, comprising steps of:
providing a pressed main body comprising at least one predetermined recess;
providing at least one clip functioning as an external connecting contact;
assembling the pressed main body and the clip; and
deformedly pressurizing the clip to be engaged to the predetermined recess, thereby tightly combining the pressed main body and the clip.

12. The manufacturing method as claimed in claim 11, wherein a cross section of the predetermined recess comprises an internal slant angle.

13. The manufacturing method as claimed in claim 12, wherein the internal slant angle is substantially equal to 12-15 degree with respect to a horizontal level.

14. The manufacturing method as claimed in claim 11, further comprising a step of providing a jig used to exert a force and permanently deform the clip so as to allow the clip to be engaged with the predetermined recess.

15. The manufacturing method as claimed in claim 11, wherein the powder-compressed assembly comprises two clips, and the pressed main body comprises a first lateral side, a second lateral side opposite to the first lateral side, and two predetermined recesses respectively close to the first lateral side and the second lateral side for allowing the clips to be engaged with the predetermined recesses, respectively.

16. The manufacturing method as claimed in claim 11, wherein the clip comprises a first end and a second end, and the pressed main body comprises a top side, a bottom side opposite to the top side, and two predetermined recesses respectively disposed at the top side and the bottom side, for allowing the first end and the second end of the clip to be engaged with the predetermined recesses, respectively.

17. The manufacturing method as claimed in claim 11, wherein the predetermined recess is formed with the pressed main body as a single piece by a single powder-compressed casting formation.

18. The manufacturing method as claimed in claim 11, wherein the powder-compressed assembly is applied to a surface mount technology component.

19. The manufacturing method as claimed in claim 18, wherein the surface mount technology (SMT) component comprises an inductor.

20. The manufacturing method as claimed in claim 11, wherein the pressed main body is a powder-compressed main body, and the at least one clip is a metal clip.
